(19) United States
(12) Patent Application Publication
(10) Pub. No.: US 2021/0106012 A1
(43) Pub. Date: Apr. 15, 2021

(54) Method for Increasing the Content Of Thiol Precursors in Plants

(71) Applicant: Danstar Ferment AG, Zug (CH)

(72) Inventors: Matthieu MOREL, Villeneuve les Avignon (FR); Jean-Marc SANCHEZ, Daux (FR)

(21) Appl. No.: 17/041,204

(22) PCT Filed: Mar. 26, 2019
(86) PCT No.: PCT/EP2019/057642

§ 371 Date: Sep. 24, 2020

(30) Foreign Application Priority Data
Mar. 26, 2018 (EP) 18290023.3

(51) Int. Cl. A01N 63/32; C05F 11/08; C12G 1/02

(52) U.S. Cl. CPC A01N 63/32; C12G 1/02; C05F 11/08

(57) ABSTRACT

The present disclosure concerns a new method of increasing the thiol precursor content of grape berries by treating the vines with a glutathione-enriched yeast.

### TECHNOLOGICAL FIELD

The present disclosure relates to a method of using glutathione-enriched yeast on grapes, vines and leaves prior to harvesting the fruits in order to increase the content or concentration of thiol precursors in the fruits in comparison with an untreated control.

### BACKGROUND

The aroma of a product is often one of the most important factors in determining the quality and intrinsic value of the product. For example, small variations in the presence and concentration of volatile aroma compounds can mean the difference between a premium and an average table wine.

In the case of wine, some of the most potent aroma compounds are volatile or varietal thiols like 3-mercaptohexan-1-ol (3MH), 3-mercaptohexyl acetate (3MHA) and 4-mercapto-4-methylpentan-2-one (4MM). They have particularly low detection thresholds. Their presence is considered essential for creating unique varietal flavour attributes which contribute positively to wine. These volatile thiols are normally non-detectable in grape juice but are synthesized and released by the yeast from a range of precursors during alcoholic fermentation. Indeed, these aromas exist in grapes as non-volatile S-cysteine conjugate precursors. The concentration of volatile thiols in wine is directly related to the concentration of their precursors in the grapes, even though only a minor portion (<5%) of these precursors is actually concerted to aroma compounds (The Science of Grapevines, Second Edition).

Previous studies have shown that nitrogen deficiency reduces the aromatic quality of, for example, Sauvignon blanc, as well as its potential for ageing. This is thought to be linked to the reduced synthesis of volatile thiol precursors, as well as of glutathione, which plays an important role in protecting volatile thiols from oxidation. Studies had demonstrated that a foliar application of nitrogen improved vine nitrogen status and enhanced aroma expression of white and rosé wines (e.g. grapes Colombard, Sauvignon, Melon, Gros Manseng or Négrette). This effect was also enhanced when nitrogen and sulfur were applied simultaneously. Furthermore, moderate water stress of grapevines after fruit set has been demonstrated to increase the concentration of conjugated thiol precursors and produced wines of a high quality (Peyrot des Gachons et al., 2005). Thus, formation of wine thiol precursors is a dynamic process, which can be influenced by vineyard and winery processing operations.

Glutathione is important in wine because it has the ability to scavenge ortho-quinones, main protagonists of color browning and aroma loss due to oxidation mechanisms. Because it has a very low oxydoreduction potential, it can act as a strong buffer in many cellular oxydoreduction reactions. It has been known for years that it is a more potent anti-oxidant than ascorbic acid. It then plays a critical role in preventing the oxidation of must phenols as it can react via its —SH group with caftaric acid—one of the most susceptible phenols to oxidation in musts and generate Grape Reaction Product (GRP) which is a stable and colorless compound (Moutounet et al, 2001). Notably, this mechanism has been shown for GSH and not for the other compounds present in must or in yeast, and possessing SH-group (such as cystein or glutamyl-cystein for instance). GSH can also compete with several thiols (aromatic compounds such as 3-mercapto-hexanol (3MH), its acetate 3-mercapto-hexanol acetate (3MH-A) and 4-methyl-mercapto-pentanone (4MMP)) present in wines under the form of precursors or aromatic molecules, for o-quinones thus protecting certain wine aromas (Dubourdieu et al, 2004). The effect of GSH on wine as a natural anti-oxidant for the preservation of wine aroma and colour is well understood now. Having high levels of glutathione in wine is then important for the preservation of aroma and color. The level of glutathione can vary in must as it is based on grape varietals, viticultural practices and the winemaking practices. In U.S. Pat. No. 8,268,372, a glutathione-enriched yeast is introduced into a must in order to obtain fresh, fruitier white wines, with complex aromas, and that, during the ageing of these wines, the freshness of these aromas is preserved and browning is avoided.

While the effect of a glutathione-enriched yeast for the prevention of defective ageing of white wines has been studied and reported, there are no previous reports on the effect of using a glutathione-enriched yeast on grapes, vines and leaves prior to harvesting the fruits in order to increase the content or concentration of thiol precursors in the grape berries. There is thus a need to provide further method for altering the character and nature of fruits such as grapes in order to increase the amount of precursor thiols that grapes and grapevines produce which non-volatile thiol precursors will release the volatile thiols during the fermentation.

### BRIEF SUMMARY

The present disclosure relates to a new method of increasing the thio precursor content of grape berries by treating the vines with a glutathione-enriched yeast.

In a first aspect, the present disclosure concerns a method for increasing the content of thiol precursors in grapes comprising applying an effective amount of a glutathione-enriched yeast to the grapes and foliage after fruit set thereby giving grapes an increased content of thiol precursors compared to untreated grapes. In an embodiment, the grapes are white or red grapes. In another embodiment, the white grapes are Sauvignon grapes Gewurtzraminer grapes, Riesling grapes or Verdejo grapes. In still another embodiment, the glutathione-enriched yeast is an active glutathione-enriched yeast, an inactivated glutathione-enriched yeast, a glutathione-enriched yeast extract, a glutathione-enriched yeast autolysate, glutathione-enriched yeast cell walls, glutathione-enriched yeast derivatives or combinations thereof. In an embodiment, the glutathione-enriched yeast is a glutathione-enriched yeast extract. In an embodiment, the yeast is a Saccharomyces. In another embodiment, the yeast is a non-Saccharomyces yeast. In still another embodiment, the yeast belongs to the species S. cerevisiae or S. cerevisiae var. boulardii. In yet another embodiment, the non-Saccharomyces yeast belongs to the genera Candida, Torula, Hanseniaspora, Hansenula, Kluyveromyces, Metschnikowia, Pichia, Starmerella, Torulaspora or mixture thereof. In an embodiment, the grapes are treated between the beginning of veraison and the end of veraison. In still another embodiment, the thiol precursors are the precursors of volatile thiols 3-mercaptohexan-1-ol or 4-mercapto-4-methylpentan-2-one. In yet another embodiment, the thiol precursors are cysteine-3M (S-3-(hexan-1-ol)-L-cysteine), cysteinyl-glycine-3M (3-S-cysteinylglycinehexan-1-ol), gamma-glutamyl-cysteine-3MH (S-3-(hexan-1-ol)-gamma-glutamyl-cysteine) or glutathione-3MH (S-(3-hexan-1-ol)-glutathione). In an embodiment, the thiol precursor is glutathione-3MH (S-(3-hexan-1-ol)-glutathione). In an embodiment, the glutathione-enriched yeast contains at least 0.5% of glutathione, at least 1% of glutathione, at least 2% of glutathione, at least 3% of glutathione, at least 4% of glutathione, at least 5% of glutathione, at least 6% of glutathione, at least 7% of glutathione, at least 8% of glutathione, at least 9% of glutathione or at least 10% of glutathione by weight relative to the weight of solids of the yeast. In another embodiment, said glutathione-enriched yeast is applied to the grapes and foliage at a rate of 0.05 to 20 kg/ha, 0.1 to 20 kg/ha, 0.5 to 20 kg/ha, 1 to 15 kg/ha, 1 to 10 kg/ha, 2 to 10 kg/ha or 2 to 5 kg/ha. In still another embodiment, said glutathione-enriched yeast is applied to the grapes and foliage at a rate of at least 2 kg/ha.

In a second aspect, the present disclosure concerns a method for producing a grape preparation with an increased content of thiol precursors in grapes comprising (1) applying an effective amount of a glutathione-enriched yeast to the grapes and foliage after fruit set, and (2) harvesting and processing the grapes to obtain the grape preparation which has an increased content of thiol precursors. In an embodiment, the grapes are white or red grapes.

In another embodiment, the white grapes are Sauvignon grapes Gewurtzraminer grapes, Riesling grapes or Verdejo grapes. In still another embodiment, the glutathione-enriched yeast is an active glutathione-enriched yeast, an inactivated glutathione-enriched yeast, a glutathione-enriched yeast extract, a glutathione-enriched yeast autolysate, glutathione-enriched yeast cell walls, glutathione-enriched yeast derivatives or combinations thereof. In an embodiment, the glutathione-enriched yeast is a glutathione-enriched yeast extract. In an embodiment, the yeast is a Saccharomyces. In another embodiment, the yeast is a non-Saccharomyces yeast. In still another embodiment, the yeast belongs to the species S. cerevisiae or S. cerevisiae var. boulardii. In yet another embodiment, the non-Saccharomyces yeast belongs to the genera Candida, Torula, Hanseniaspora, Hansenula, Kluyveromyces, Metschnikowia, Pichia, Starmerella, Torulaspora or mixture thereof. In an embodiment, the grapes are treated between the beginning of veraison and the end of veraison. In still another embodiment, the thiol precursors are the precursors of volatile thiols 3-mercaptohexan-1-ol or 4-mercapto-4-methylpentan-2-one. In yet another embodiment, the thiol precursors are cysteine-3M (S-3-(hexan-1-ol)-L-cysteine), cysteinyl-glycine-3M (3-S-cysteinylglycinehexan-1-ol), gamma-glutamyl-cysteine-3MH (S-3-(hexan-1-ol)-gamma-glutamyl-cysteine) or glutathione-3MH (S-(3-hexan-1-ol)-glutathione). In an embodiment, the thiol precursor is glutathione-3MH (S-(3-hexan-1-ol)-glutathione). In an embodiment, the glutathione-enriched yeast contains at least 0.5% of glutathione, at least 1% of glutathione, at least 2% of glutathione, at least 3% of glutathione, at least 4% of glutathione, at least 5% of glutathione, at least 6% of glutathione, at least 7% of glutathione, at least 8% of glutathione, at least 9% of glutathione or at least 10% of glutathione by weight relative to the weight of solids of the yeast. In another embodiment, said glutathione-enriched yeast is applied to the grapes and foliage at a rate of 0.05 to 20 kg/ha, 0.1 to 20 kg/ha, 0.5 to 20 kg/ha, 1 to 15 kg/ha, 1 to 10 kg/ha, 2 to 10 kg/ha or 2 to 5 kg/ha. In still another embodiment, said glutathione-enriched yeast Is applied to the grapes and foliage at a rate of at least 2 kg/ha.

In a third aspect, the present disclosure concerns a wine grape extract, wine grape juice, wine or wine grape press cake comprising thiol precursors obtained from grapes treated with a glutathione-enriched yeast, wherein due to the treatment of the grapes with the glutathione-enriched yeast, the content of the thiol precursors is increased. In an embodiment, the grapes are white or red grapes. In another embodiment, the white grapes are Sauvignon grapes Gewurtzraminer grapes, Riesling grapes or Verdejo grapes. In still another embodiment, the glutathione-enriched yeast is an active glutathione-enriched yeast, an inactivated glutathione-enriched yeast, a glutathione-enriched yeast extract, a glutathione-enriched yeast autolysate, glutathione-enriched yeast cell walls, glutathione-enriched yeast derivatives or combinations thereof. In an embodiment, the glutathione-enriched yeast is a glutathione-enriched yeast extract. In an embodiment, the yeast is a Saccharomyces. In another embodiment, the yeast is a non-Saccharomyces yeast. In still another embodiment, the yeast belongs to the species S. cerevisiae or S. cerevisiae var. boulardii. In yet another embodiment, the non-Saccharomyces yeast belongs to the genera Candida, Torula, Hanseniaspora, Hansenula, Kluyveromyces, Metschnikowia, Pichia, Starmerella, Torulaspora or mixture thereof. In an embodiment, the grapes are treated between the beginning of veraison and the end of veraison. In still another embodiment, the thiol precursors are the precursors of volatile thiols 3-mercaptohexan-1-ol or 4-mercapto-4-methylpentan-2-one. In yet another embodiment, the thiol precursors are cysteine-3M (S-3-(hexan-1-ol)-L-cysteine), cysteinyl-glycine-3M (3-S-cysteinylglycinehexan-1-ol), gamma-glutamyl-cysteine-3MH (S-3-(hexan-1-ol)-gamma-glutamyl-cysteine) or glutathione-3MH (S-(3-hexan-1-ol)-glutathione). In an embodiment, the thiol precursor is glutathione-3MH (S-(3-hexan-1-ol)-glutathione). In an embodiment, the glutathione-enriched yeast contains at least 0.5% of glutathione, at least 1% of glutathione, at least 2% of glutathione, at least 3% of glutathione, at least 4% of glutathione, at least 5% of glutathione, at least 6% of glutathione, at least 7% of glutathione, at least 8% of glutathione, at least 9% of glutathione or at least 10% of glutathione by weight relative to the weight of solids of the yeast. In another embodiment, said glutathione-enriched yeast is applied to the grapes and foliage at a rate of 0.05 to 20 kg/ha, 0.1 to 20 kg/ha, 0.5 to 20 kg/ha, 1 to 15 kg/ha, 1 to 10 kg/ha, 2 to 10 kg/ha or 2 to 5 kg/ha. In still another embodiment, said glutathione-enriched yeast is applied to the grapes and foliage at a rate of at least 2 kg/ha.

In a fourth aspect, the present disclosure concerns the use of an effective amount of a glutathione-enriched yeast for increasing the content of thiol precursors in grapes comprising applying to the grapes and foliage after fruit set said glutathione-enriched yeast thereby giving grapes an increased content of thiol precursors compared to untreated grapes. In an embodiment, the grapes are white or red grapes. In another embodiment, the white grapes are Sauvignon grapes Gewurtzraminer grapes, Riesling grapes or Verdejo grapes. In still another embodiment, the glutathione-enriched yeast is an active glutathione-enriched yeast, an inactivated glutathione-enriched yeast, a glutathione-enriched yeast extract, a glutathione-enriched yeast autolysate, glutathione-enriched yeast cell walls, glutathione-enriched yeast derivatives or combinations thereof. In an embodiment, the glutathione-enriched yeast is a glutathione-enriched yeast extract. In an embodiment, the yeast is a Saccharomyces. In another embodiment, the yeast is a non-Saccharomyces yeast. In still another embodiment, the yeast belongs to the species S. cerevisiae or S. cerevisiae var. boulardii. In yet another embodiment, the non-Saccharomyces yeast belongs to the genera Candida, Torula, Hanseniaspora, Hansenula, Kluyveromyces, Metschnikowia, Pichia, Starmerella, Torulaspora or mixture thereof. In an embodiment, the grapes are treated between the beginning of veraison and the end of veraison. In still another embodiment, the thiol precursors are the precursors of volatile thiols 3-mercaptohexan-1-ol or 4-mercapto-4-methylpentan-2-one. In yet another embodiment, the thiol precursors are cysteine-3M (S-3-(hexan-1-ol)-L-cysteine), cysteinyl-glycine-3M (3-S-cysteinylglycinehexan-1-ol), gamma-glutamyl-cysteine-3MH (S-3-(hexan-1-ol)-gamma-glutamyl-cysteine) or glutathione-3MH (S-(3-hexan-1-ol)-glutathione). In an embodiment, the thiol precursor is glutathione-3MH (S-(3-hexan-1-ol)-glutathione). In an embodiment, the glutathione-enriched yeast contains at least 0.5% of glutathione, at least 1% of glutathione, at least 2% of glutathione, at least 3% of glutathione, at least 4% of glutathione, at least 5% of glutathione, at least 6% of glutathione, at least 7% of glutathione, at least 8% of glutathione, at least 9% of glutathione or at least 10% of glutathione by weight relative to the weight of solids of the yeast. In another embodiment, said glutathione-enriched yeast is applied to the grapes and foliage at a rate of 0.05 to 20 kg/ha, 0.1 to 20 kg/ha, 0.5 to 20 kg/ha, 1 to 15 kg/ha, 1 to 10 kg/ha, 2 to 10 kg/ha or 2 to 5 kg/ha. In still another embodiment, said glutathione-enriched yeast is applied to the grapes and foliage at a rate of at least 2 kg/ha.

### DETAILED DESCRIPTION

It has been unexpectedly discovered that a preharvest application of a glutathione-enriched yeast resulted in an increased thiol precursor content in the grapes in comparison with untreated controls. The present disclosure provides a method for increasing the content of thiol precursors in grapes by application of a glutathione-enriched yeast to the grapes, vines and/or leaves before the grape berries are harvested.

The present disclosure provides grape berries with an increased content in thiol precursors in comparison with untreated controls. In this regard, examples of volatile or varietal thiol compounds and their non-volatile precursors present in grapes are as follows:

4MMP (4-mercapto-4-methylpentan-2-one) and its non-volatile precursor Cys-4MMP (4-(4-methylpentan-2-one)-L-cysteine), CysGly-4MMP precursor (S-4-mercapto-4-methylpentan-2-one-I-cysteinyl-glycine), gamma GluCys-4MMP precursor (S-4-mercapto-4-methylpentan-2-one-N-(L-gamma-glutamyl)-L-cysteine) and Glut-4MMP precursor (S-4-(4-methylpentan-2-one)-glutathione); 3MHA (3-mercaptohexyl acetate) and its non-volatile pre-precursor Cys-3MH (3-(hexan-I-ol)-L-cysteine); the direct precursor of 3MHA is 3MH (3-mercaptohexan-1-ol); 3MH (3-mercaptohexan-1-ol) and its non-volatile precursors Cys-3MH precursor (S-3-(hexan-1-ol)-L-cysteine), Cysgly-3-MH precursor (3-S-cysteinylglycinehexan-1-ol), gamma-GluCys-3MH precursor (S-3-(hexan-1-ol)-gamma-glutamyl-cysteine) and 3MH-S-glut precursor (S-(3-hexan-1-ol)-glutathione); and 4MMP0H (4-mercapto-4-methylpentan-2-ol) and its non-volatile precursor S-4-(4-methylpentan-2-ol)-L-cysteine.

In the context of the present disclosure, the expression “enriched yeast” expressly denotes a glutathione-enriched yeast. The term “glutathione” is intended to mean the molecule composed of the three amino acids glutamate-cysteine-glycine, in its oxidized or reduced form.

The production of glutathione-enriched yeast is well known to those skilled in the art who know how to prepare it by means of one of the techniques at their disposal; see, for example, Catalino et al., 1992, Applied Microbiology and Biotechnology, Ed Springer-Verlag, pp. 141-146.

In the method according to the present disclosure, said glutathione-enriched yeast contains more than 0.5% of glutathione by weight relative to the weight of solids of the yeast. Advantageously, said glutathione-enriched yeast contains at least 1% of glutathione, at least 2% of glutathone, at least 3% of glutathione, at least 4% of glutathione, at least 5% of glutathione, at least 6% of glutathione, at least 7% of glutathione, at least 8% of glutathione, at least 9% of glutathione or at least 10% of glutathione by weight relative to the weight of solids of the yeast.

Moreover, the enriched yeast can be applied to the fruits (e.g. grapes), foliage and/or grapevines in the form of inactive dry yeast, but also in the form of active dry yeast. There is in fact nothing to stop the user carrying out several introductions of enriched yeast, taken in different forms. Alternatively, the glutathione-enriched yeast can be applied to the fruits (e.g. grapes), foliage and/or grapevines in the form of inactive liquid yeast or active liquid yeast. Alternatively, the yeast composition applied to the fruits (e.g. grapes), foliage and/or grapevines may comprise at least one live yeast, inactivated yeast, yeast extract, yeast autolysate, yeast cell walls, any other whole yeast derivatives obtained by physico-chemical and/or enzymatic treatment, or any combination of the above. The physico-chemical treatment may comprise a temperature and/or pH treatment. In an embodiment, the yeast composition comprises a yeast extract. The various processes and suitable conditions for preparing the different yeast compositions are known to the person skilled in the art.

The yeast may be any suitable Saccharomyces or a non-Saccharomyces yeast as, for example, from the genera Candida, Torula, Hanseniaspora, Hansenula, Kluyveromyces, Metschnikowia, Pichia, Starmerella, Torulaspora. In an embodiment, the genera Saccharomyces includes, without limitation, S. cerevisiae or S. cerevisiae var. boulardii. In an embodiment, a single bacterial strain can be used. Alternatively, two or more different bacterial strains or species can be used in combination.

The glutathione-enriched yeast is applied to the grapevines and/or foliage after berry set to achieve the desired effect on the concentration of the thiol precursor content in the grape berries. In an embodiment, the timing of said glutathione-enriched yeast application is during the period of the pre-veraison (approximately 3 weeks before veraison, where veraison is defined as berry softening) through the post-veraison period but prior to harvest. In another embodiment, the timing range is from initial flowering to prior to harvest.

In the context of the present disclosure, a glutathione-enriched yeast is contacted or applied to the fruits, foliage and/or grapevines via e.g. spraying an effective amount of the enriched yeast to the grape berries before harvest in one treatment or via multiple treatments. The term “contacted or applied” as used herein refers to any mode of bringing together the surface to be treated, e.g. the aerial parts of a plant or fruits, with a glutathione-enriched yeast. The method of contacting the glutathione-enriched yeast with a plant is not limited to a specific method as long as it enables an efficient contact of the yeast with the plant or plant parts. Spraying is specifically useful in an industrial production method.

The amount of glutathione-enriched yeast applied to the plant is an effective amount to increase the content or concentration of thiol precursors in the grape berries in comparison with untreated controls. Suitably, the amount applied to the plant is a conventional amount, conventional in the sense of comparable to the amount of known nitrogen or nitrogen and sulfur that are applied to grapevines the increase of thiol precursors and/or thiols level in grape berries and must. However, it has been surprisingly discovered that lesser amounts can be used of glutathione-enriched yeast than conventional nitrogen or nitrogen and sulfur application to obtain comparable results. The glutathione-enriched yeast or composition of the present disclosure is applied to the grape berries, foliage and/or grapevines at application rates of 0.05 to 20 kg/ha, 0.1 to 20 kg/ha, 0.5 to 20 kg/ha, 1 to 15 kg/ha, 1 to 10 kg/ha, 2 to 10 kg/ha or 2 to 5 kg/ha. In an embodiment, the rate of application is at least 2 kg/ha.

Agricultural carriers may be used in combination with the enriched yeast of the present disclosure and include, for example, water, fertilizers, pesticides, plant-based oils, humectants, or combinations thereof. Adjuvants and surfactants could also be added to the enriched yeast.

In the context of the present disclosure, the white grapes used include varieties from the following groups, but are not limited to, Siria, Malvasia Fina, Thompson seedless, Semillon, Chenin blanc, Loureiro, Albariho, Trajadura, Sauvignon blanc, Verdejo, Chardonnay, Gewurtzraminer, Riesling or mixtures thereof. Moreover, red grapes can also be used and include varieties from the following groups, but are not limited to, Grenache noir, Syrah, Cabernet franc, Cabernet sauvignon, Merlot, Pinot noir, Malbec or mixtures thereof.

The word “comprising” in the claims may be replaced by “consisting essentially of” or with “consisting of,” according to standard practice in patent law.

The following example serves to further describe and define the invention, and is not intended to limit the invention in any way.

### Example 1

A replicated field experiment was conducted on the white wine grape cultivar ‘Sauvignon” in the growing region of Lleida, Spain to test the effect of glutathione-enriched yeast on white grapes. Two treatments were tested: untreated control and 2 kg/ha of glutathione-enriched yeast applied after the start of the veraison. There were 8 replicates of 10 vines for each treatment and the experiment was laid out in a randomized complete block (RCB) design. A glutathione-enriched yeast extract (belonging to the species S. cerevisiae and contains 5% of reduced glutathione and oxidized glutathione disulfide (GSSG)) was applied using a commercial sprayer at a concentration of 2 kg/ha in a volume of approximately 1501/ha in order to achieve thorough and complete coverage of the grape bunches and to the foliage as well.

Samples of 200 grape berries were harvested for each treatment at the time of commercial harvest for berry analysis. Thiol precursors were measured by HPLC.

The results of the chemical analysis are presented in Table 1.

TABLE 1
Effect of a glutathione-enriched yeast extract treatment on
the thiol precursor concentration of grape berries at harvest

| Treatment | 3MH-S-glut (μg/kg) |
|---|---|
| Untreated control | 282 |
| Glutathione-enriched yeast extract | 398 |

As shown in Table 1, the glutathione-enriched yeast extract treatment increased the concentration of thiol precursors (the gluthation-3MH precursor) in the grape berries compared to the untreated control.

Furthermore, as shown in Table 2, apart from increasing the thiol precursor concentration, the application of the glutathione-enriched yeast extract increased the level of total acidity, tartaric acid and malic acid in the grape berries which in turn will result in wines with greater freshness and improved aromatic intensity.

TABLE 2
Total content of nitrogen (N), pH, total acidity, tartaric acid,
malic acid and sugars in the grape berries subjected to the application
of the glutathione-enriched yeast extract treatment

| | | Glutathione-enriched |
|---|---|---|
| Parameters | Untreated control | yeast extract |
| Total weight (200 berries) (g) | 165.29 | 192.87 |
| pH | 3.78 | 3.7 |
| Total acidity (g/l) | 17.32 | 19.51 |
| Tartaric acid (g/l) | 3.59 | 4.66 |
| Malic acid (g/l) | 1.56 | 2.66 |
| Total N (%) | 0.255 | 0.293 |
| Sugars (Brix) | 24.2 | 24.4 |

While the invention has been described in connection with specific embodiments thereof, it will be understood that the scope of the claims should not be limited by the preferred embodiments set forth in the examples, but should be given the broadest interpretation consistent with the description as a whole.

### REFERENCES

Dubourdieu et al. 2003. Rôle du glutathion sur l'évolution aromatique des vins blancs secs. Vinidea.net Wine Internet Technical Journal No. 17.
Moutounet M., Mazauric J.-P., Ducournau P. and Lemaire T. 2001. Wine micro-oxygenation. Principles and technological applications. Industria delle Bevande. 30: 253.
Peyrot des Gachons, C., Leeuwen, C., Tominaga, T., Soyer, J., Gaudillere, J., and Dubourdeu, D. 2005. Influence of water and nitrogen deficit on fruit ripening and aroma potential of Vitis vinifera L cv Sauvignon Blanc in field conditions. Journal of the Science of Food and agriculture, 85: 73-85.
Keller, M. 2015. The science of grapevines—Anatomy and physiology. Second Edition. Academic Press, Elsevier.

1-63. (canceled)

64. A method for:
(i) increasing the content of thiol precursors in grapes comprising applying an effective amount of a glutathione-enriched yeast to the grapes and foliage after fruit set thereby giving grapes an increased content of thiol precursors compared to untreated grapes; or
(ii) producing a grape preparation with an increased content of thiol precursors comprising:
(1) applying an effective amount of a glutathione-enriched yeast to the grapes and foliage after fruit set; and
(2) harvesting and processing the grapes to obtain the grape preparation which has an increased content of thiol precursors.

65. The method of claim 64, wherein the grapes are white or red grapes; optionally wherein the white grapes are Sauvignon grapes Gewurtzraminer grapes, Riesling grapes or Verdejo grapes.

66. The method of claim 64, wherein the glutathione-enriched yeast is an active glutathione-enriched yeast, an inactivated glutathione-enriched yeast, a glutathione-enriched yeast extract, a glutathione-enriched yeast autolysate, glutathione-enriched yeast cell walls, glutathione-enriched yeast derivatives or combinations thereof, or wherein the glutathione-enriched yeast is a glutathione-enriched yeast extract.

67. The method of claim 64, wherein:
(a) the yeast is a Saccharomyces; optionally wherein the yeast belongs to the species S. cerevisiae or S. cerevisiae var. boulardii; or
(b) the yeast is a non-Saccharomyces yeast; optionally wherein the non-Saccharomyces yeast belongs to the genera Candida, Torula, Hanseniaspora, Hansenula, Kluyveromyces, Metschnikowia, Pichia, Starmerella, Torulaspora or mixture thereof.

68. The method of claim 64, wherein the glutathione-enriched yeast is applied between the beginning of veraison and the end of veraison, optionally wherein:
(a) the glutathione-enriched yeast is applied at at least 2% veraison, optionally wherein the glutathione-enriched yeast is applied between 2% and 98% veraison, between 2% and 90% veraison, between 2% and 80% veraison, between 2% and 70% veraison, between 2% and 60% veraison, between 2% and 50% veraison, between 2% and 40% veraison, between 2% and 30% veraison, between 2% and 20% veraison, between 2% and 15% veraison, between 2% and 10% veraison, between 2% and 8% veraison, or between 2% and 6% veraison;
(b) the glutathione-enriched yeast is applied at phenological growth stage E-L 27 or thereafter;
(c) the glutathione-enriched yeast is applied at phenological growth stage E-L 34 or thereafter, optionally wherein the glutathione-enriched yeast is applied between phenological growth stages E-L 34 and E-L 39, between phenological growth stages E-L 34 and E-L 38, between phenological growth stages E-L 34 and E-L 37, or between phenological growth stages E-L 34 and E-L 36; or
(d) the glutathione-enriched yeast is applied at phenological growth stages E-L 34 and/or E-L 35.

69. The method of claim 64, wherein a single application of the glutathione-enriched yeast is performed.

70. The method of claim 64, wherein the thiol precursors are selected from the group consisting of cysteine-3M (S-3-(hexan-1-ol)-L-cysteine), cysteinyl-glycine-3M (3-S-cysteinylglycinehexan-1-ol), gamma-glutamyl-cysteine-3MH (S-3-(hexan-1-ol)-gamma-glutamyl-cysteine), glutathione-3MH (S-(3-hexan-1-ol)-glutathione), Cys-4MMP (4-(4-methylpentan-2-one)-L-cysteine), CysGly-4MMP precursor (S-4-mercapto-4-methylpentan-2-one-1-cysteinyl-glycine), gamma GluCys-4MMP precursor (S-4-mercapto-4-methylpentan-2-one-N-(L-gamma-glutamyl)-L-cysteine), Glut-4MMP precursor (S-4-(4-methylpentan-2-one)-glutathione), and combinations thereof, or wherein the thiol precursor is glutathione-3MH (S-(3-hexan-1-ol)-glutathione) and/or Cys-4MMP (4-(4-methylpentan-2-one)-L-cysteine).

71. The method of claim 64, wherein the thiol precursors are the precursors of volatile thiol 3-mercaptohexan-1-ol (3MH) and/or volatile thiol 4-mercapto-4-methylpentan-2-one (4MPP).

72. The method of claim 64, wherein said glutathione-enriched yeast contains at least 0.5% of glutathione, at least 1% of glutathione, at least 2% of glutathione, at least 3% of glutathione, at least 4% of glutathione, at least 5% of glutathione, at least 6% of glutathione, at least 7% of glutathione, at least 8% of glutathione, at least 9% of glutathione or at least 10% of glutathione by weight relative to the weight of solids of the yeast.

73. The method of claim 64, said glutathione-enriched yeast is applied to the grapes and foliage at a rate of 0.05 to 20 kg/ha, 0.1 to 20 kg/ha, 0.5 to 20 kg/ha, 1 to 15 kg/ha, 1 to 10 kg/ha, 2 to 10 kg/ha or 2 to 5 kg/ha; preferably wherein said glutathione-enriched yeast is applied to the grapes and foliage at a rate of at least 2 kg/ha.

74. The method of claim 64, wherein the content of thiol precursors in the treated grapes is:
(a) increased by at least 5%, at least 10%, at least 15%, at least 20%, at least 25%, at least 30%, at least 35%, at least 40%, at least 45%, at least 50%, at least 55%, or at least 60% compared to untreated grapes; or
(b) increased by at least 1.05-fold, at least 1.1-fold, at least 1.15-fold, at least 1.2-fold, at least 1.25-fold, at least 1.3-fold, at least 1.35-fold, at least 1.4-fold, at least 1.45-fold, at least 1.5-fold, at least 1.55-fold, or at least 1.6-fold compared untreated grapes.

75. A grape preparation produced by the method of claim 64.

76. A wine grape extract, wine grape juice, wine or wine grape press cake comprising thiol precursors obtained from grapes treated with a glutathione-enriched yeast, wherein due to the treatment of the grapes with the glutathione-enriched yeast, the content of the thiol precursors is increased.

77. The wine grape extract, wine grape juice, wine or wine grape press cake of claim 76, wherein the thiol precursors are selected from the group consisting of cysteine-3M (S-3-(hexan-1-ol)-L-cysteine), cysteinyl-glycine-3M (3-S-cysteinylglycinehexan-1-ol), gamma-glutamyl-cysteine-3MH (S-3-(hexan-1-ol)-gamma-glutamyl-cysteine), glutathione-3MH (S-(3-hexan-1-ol)-glutathione), Cys-4MMP (4-(4-methylpentan-2-one)-L-cysteine), CysGly-4MMP precursor (S-4-mercapto-4-methylpentan-2-one-1-cysteinyl-glycine), gamma GluCys-4MMP precursor (S-4-mercapto-4-methylpentan-2-one-N-(L-gamma-glutamyl)-L-cysteine), Glut-4MMP precursor (S-4-(4-methylpentan-2-one)-glutathione), and combinations thereof, or wherein the thiol precursors are glutathione-3MH (S-(3-hexan-1-ol)-glutathione) and/or Cys-4MMP (4-(4-methylpentan-2-one)-L-cysteine).

78. The wine grape extract, wine grape juice, wine or wine grape press cake of claim 76, wherein the thiol precursors are the precursors of volatile thiol 3-mercaptohexan-1-ol (3MH) and/or the precursors of volatile thiol 4-mercapto-4-methylpentan-2-one (4MPP).

79. Use of an effective amount of a glutathione-enriched yeast for increasing the content of thiol precursors in grapes comprising applying to the grapes and foliage after fruit set said glutathione-enriched yeast thereby giving grapes an increased content of thiol precursors compared to untreated grapes.

80. The use of claim 79, wherein the grapes are white or red grapes; optionally wherein the white grapes are Sauvignon grapes Gewurtzraminer grapes, Riesling grapes or Verdejo grapes.

81. The use of claim 79, wherein the glutathione-enriched yeast is an active glutathione-enriched yeast, an inactivated glutathione-enriched yeast, a glutathione-enriched yeast extract, a glutathione-enriched yeast autolysate, glutathione-enriched yeast cell walls, glutathione-enriched yeast derivatives or combinations thereof, or wherein the glutathione-enriched yeast is a glutathione-enriched yeast extract.

82. The use of claim 79, wherein:
(a) the yeast is a Saccharomyces; optionally wherein the yeast belongs to the species S. cerevisiae or S. cerevisiae var. boulardii; or
(b) the yeast is a non-Saccharomyces yeast; optionally wherein the non-Saccharomyces yeast belongs to the genera Candida, Torula, Hanseniaspora, Hansenula, Kluyveromyces, Metschnikowia, Pichia, Starmerella, Torulaspora or mixture thereof.

83. The use of claim 79, wherein the glutathione-enriched yeast is applied between the beginning of veraison and the end of veraison, optionally wherein:
(a) the glutathione-enriched yeast is applied at at least 2% veraison, optionally wherein the glutathione-enriched yeast is applied between 2% and 98% veraison, between 2% and 90% veraison, between 2% and 80% veraison, between 2% and 70% veraison, between 2% and 60% veraison, between 2% and 50% veraison, between 2% and 40% veraison, between 2% and 30% veraison, between 2% and 20% veraison, between 2% and 15% veraison, between 2% and 10% veraison, between 2% and 8% veraison, or between 2% and 6% veraison;
(b) the glutathione-enriched yeast is applied at phenological growth stage E-L 34 or thereafter, optionally wherein the glutathione-enriched yeast is applied between phenological growth stages E-L 34 and E-L 39, between phenological growth stages E-L 34 and E-L 38, between phenological growth stages E-L 34 and E-L 37, or between phenological growth stages E-L 34 and E-L 36; or
(c) the glutathione-enriched yeast is applied at phenological growth stages E-L 34 and/or E-L 35.

84. The use of claim 79, wherein a single application of the glutathione-enriched yeast is performed.

85. The use of claim 79, wherein the thiol precursors are selected from the group consisting of cysteine-3M (S-3-(hexan-1-ol)-L-cysteine), cysteinyl-glycine-3M (3-S-cysteinylglycinehexan-1-ol), gamma-glutamyl-cysteine-3MH (S-3-(hexan-1-ol)-gamma-glutamyl-cysteine), glutathione-3MH (S-(3-hexan-1-ol)-glutathione), Cys-4MMP (4-(4-methylpentan-2-one)-L-cysteine), CysGly-4MMP precursor (S-4-mercapto-4-methylpentan-2-one-1-cysteinyl-glycine), gamma GluCys-4MMP precursor (S-4-mercapto-4-methylpentan-2-one-N-(L-gamma-glutamyl)-L-cysteine), Glut-4MMP precursor (S-4-(4-methylpentan-2-one)-glutathione), and combinations thereof, or wherein the thiol precursors are glutathione-3MH (S-(3-hexan-1-ol)-glutathione) and/or Cys-4MMP (4-(4-methylpentan-2-one)-L-cysteine).

86. The use of claim 79, wherein the thiol precursors are the precursors of volatile thiol 3-mercaptohexan-1-ol (3MH) and/or volatile thiol 4-mercapto-4-methylpentan-2-one (4MPP).

87. The use of claim 79, wherein said glutathione-enriched yeast contains at least 0.5% of glutathione, at least 1% of glutathione, at least 2% of glutathione, at least 3% of glutathione, at least 4% of glutathione, at least 5% of glutathione, at least 6% of glutathione, at least 7% of glutathione, at least 8% of glutathione, at least 9% of glutathione or at least 10% of glutathione by weight relative to the weight of solids of the yeast.

88. The use of claim 79, said glutathione-enriched yeast is applied to the grapes and foliage at a rate of 0.05 to 20 kg/ha, 0.1 to 20 kg/ha, 0.5 to 20 kg/ha, 1 to 15 kg/ha, 1 to 10 kg/ha, 2 to 10 kg/ha or 2 to 5 kg/ha; preferably wherein said glutathione-enriched yeast is applied to the grapes and foliage at a rate of at least 2 kg/ha.

89. The use of claim 79, wherein the content of thiol precursors in the treated grapes is:
(a) increased by at least 5%, at least 10%, at least 15%, at least 20%, at least 25%, at least 30%, at least 35%, at least 40%, at least 45%, at least 50%, at least 55%, or at least 60% compared to untreated grapes; or
(b) increased by at least 1.05-fold, at least 1.1-fold, at least 1.15-fold, at least 1.2-fold, at least 1.25-fold, at least 1.3-fold, at least 1.35-fold, at least 1.4-fold, at least 1.45-fold, at least 1.5-fold, at least 1.55-fold, or at least 1.6-fold compared untreated grapes.
